(19) United States
(12) Patent Application Publication
(10) Pub. No.: US 2007/0122145 A1
(43) Pub. Date: May 31, 2007

(54) PORTABLE ELECTRONIC DEVICE WITH CAMERA MODULE

(75) Inventor: KENG-MING CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,430

(22) Filed: Aug. 4, 2006

(30) Foreign Application Priority Data
Nov. 25, 2005 (CN) 200510101798.X

(51) Int. Cl. G03B 17/00

(52) U.S. Cl. 396/529

(57) ABSTRACT

An exemplary portable electronic device with camera module includes a main body, a camera module received in the main body, and an attachable lens module. The camera module and the attachable lens module each include a magnetic element, the camera module and the attachable lens module are connected by the magnetic elements.

### FIELD OF THE INVENTION

The present invention relates generally to portable electronic devices, and more particularly relates to a portable electronic device with a camera module.

### DESCRIPTION OF RELATED ART

With the development of wireless communication and information processing, portable electronic devices, such as mobile telephones and PDAs (personal digital assistants), are now in widespread use. These electronic devices enable consumers to enjoy the convenience of high technology services, anytime and anywhere. Camera modules have been important members of the portable electronic devices.

Camera modules generally have two types of zoom: digital zoom and optical zoom. Digital zoom simply crops an image to the centre—similar to the way a software image editor works. In other words, the pixels that would have been used to capture the original or “un-zoomed” image are simply magnified. To compensate for the loss of actual pixelation, camera modules then use a process of interpolation, which adds pixels to the zoomed image using a complicated algorithm. The resulting image, however, is still far less vivid and effective than if the actual pixels had been used. On the other hand, an optical zoom magnifies the image using a real multifocal-length lens system. This means that the lens system is actually magnifying the focal length and zooming in before the image is captured in pixels.

However, for optical zooming, camera modules generally employ complicated structures for driving lenses and thereby are heavier and more expensive and larger as a result. However, in portable electronic devices, such as mobile telephones and PDAs, space is limited. Even where optical zoom is achieved in portable electronic devices, the optical zoom ratio is limited.

What is needed, therefore, is a portable electronic device with camera module which has high optical performance and ease of use.

### SUMMARY OF THE INVENTION

In a preferred embodiment, a portable electronic device with camera module includes a main body, a camera module received in the main body, and an attachable lens module. The camera module and the attachable lens module each includes a magnetic element, the camera module and the attachable lens module are connected by the magnetic elements.

Other advantages and novel features will become more apparent from the following detailed description when taken in conjunction with the accompanying drawings, in which:

### BRIEF DESCRIPTION OF THE DRAWINGS

Many aspects of the present portable electronic device with camera module can be better understood with reference to the following drawings. The components in the drawings are not necessarily to scale, the emphasis instead being placed upon clearly illustrating the principles of the present portable electronic device with camera module. Moreover, in the drawings, like reference numerals designate corresponding parts throughout the several views.

FIG. 1 is an exploded, isometric view of a portable electronic device with a camera module, in accordance with a first preferred embodiment;

FIG. 2 is an assembled view of the portable electronic device of FIG. 1;

FIG. 3 is an isometric view of a portable electronic device with a camera module before assembly, in accordance with a second preferred embodiment;

FIG. 4 is an assembled view of the portable electronic device of FIG. 3

The exemplifications set out herein illustrate at least one preferred embodiment of the invention, in one form, and such exemplifications are not to be construed as limiting the scope of the invention in any manner.

### DETAILED DESCRIPTION OF THE INVENTION

Embodiments of the present invention will now be described in detail below and with reference to the drawings.

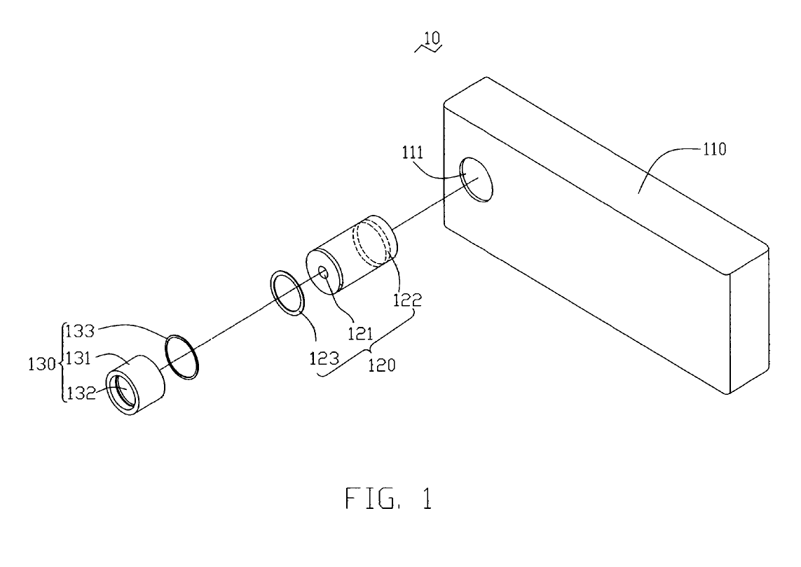

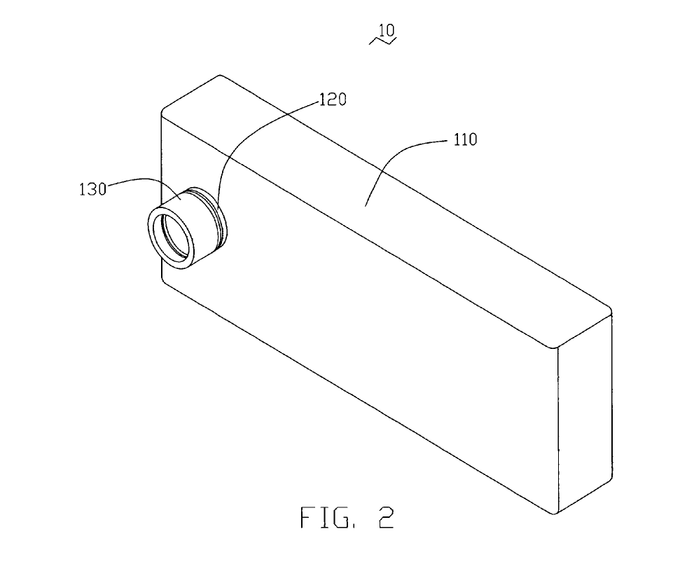

Referring to FIG. 1 and FIG. 2, a portable electronic device with a camera module such as a mobile phone 10 according to a first preferred embodiment is provided. The mobile phone 10 includes a main body 110 having a receiving cavity 111, a camera module 120 received in the receiving cavity 111, and an attachable lens module 130. The camera module 120 includes an image pick-up lens unit 121, an image sensor 122 and a first magnetic element 123. The attachable lens module 130 includes a lens barrel 131, a zoom lens unit 132 and a second magnetic element 133. The camera module 120 and the attachable lens module 130 are connected by the first magnetic element 123 and the second magnetic element 133.

The image pick-up lens unit 121 may employ a fix focus lens unit or a zoom lens unit. The image sensor 122 usually is a charge coupled device (CCD) or a complementary metal-oxide semiconductor (CMOS) device. At least one of the first magnetic element 123 and the second magnetic element 133 is made from permanently magnetic material, the other one can be made from permanently magnetic material or a magnetizable metal. The first magnetic element 123 and the second magnetic element 133 are fixed in the camera module 120 and the attachable lens module 130 respectively, and configured for connecting the camera module 120 and the attachable lens module 130 magnetically. For example, the first magnetic element 123 and the second magnetic element 133 are attached, using either adhesive or screw-thread, to the camera module 120 and the attachable lens module 130 respectively. In the preferred embodiment, the camera module 120 and the attachable lens module 130 each employs a magnetic circle pad as the first magnetic element 123 and the second magnetic element 133. The magnetic circle pads are fixed at corresponding ends of the camera module 120 and the attachable lens module 130, and the corresponding ends face towards each other.

It should be noted that, the zoom lens unit 131 employed in the attachable lens module 130 may also be replaced by other desired optical lens unit, such as fix focus lens unit, telescopic lens unit or tele-converter lens.

In operation, the camera module 120 and the attachable lens module 130 are connected by the first magnetic element 123 and the second magnetic element 133. Therefore, the camera module 120 and the attachable lens module 130 can cooperate with each other in providing high optical performance. If image pick-up operation is completed, the attachable lens module 130 can be removed from the camera module 120.

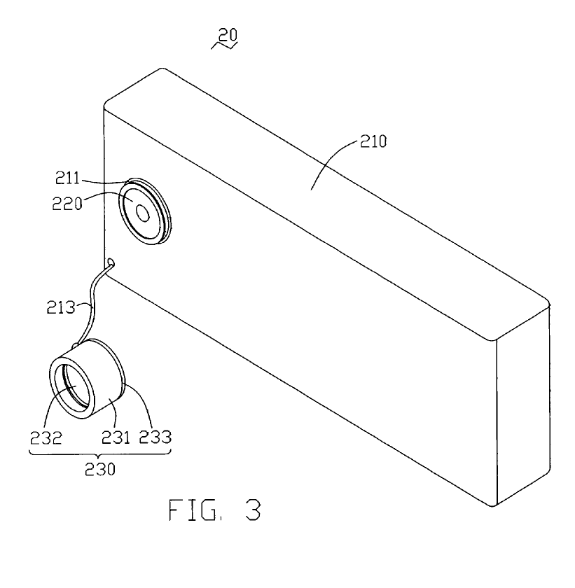

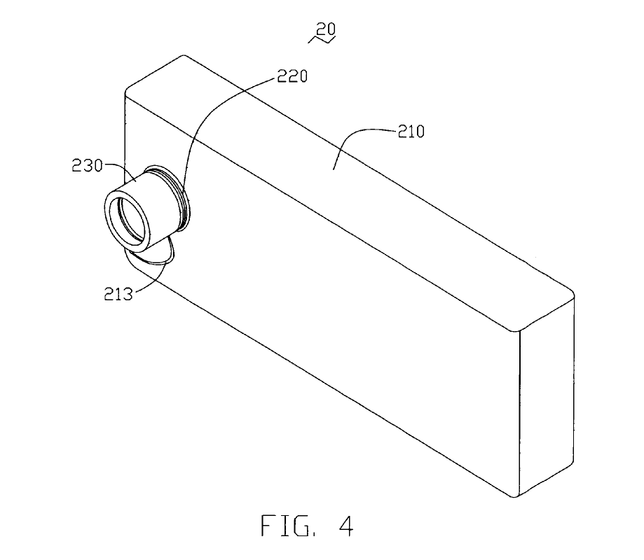

Referring to FIG. 3 and FIG. 4, a portable electronic device with a camera module such as a mobile phone 20 according to a second preferred embodiment is provided. The mobile phone 20 includes a main body 210 defining a receiving cavity 211, a camera module 220 received in the receiving cavity 211, and an attachable lens module 230. The attachable lens module 230 includes a lens barrel 231, a zoom lens unit 232 and a second magnetic element 233.

The mobile phone 20 is similar to the mobile phone 10 of the first embodiment. However, the mobile phone 20 further comprises a hanging portion 213 connecting the main body 210 and the attachable lens module 230. Therefore, when the image pick-up operation is completed, the attachable lens module 230 can be taken off from the camera module 220 and hung like a pendant from the hanging portion 213. In the preferred embodiment, the hanging portion 213 is a hanging thread.

As stated above, the portable electronic device with camera module in accordance with preferred embodiments employ attachable lens modules with camera modules during image pick-up operations and thereby providing high optical performance. Furthermore, if image pick-up operations are completed, the attachable lens modules can be taken off from the camera modules, and the attachable lens modules may employ any desired optical lens unit according to different requirements of users.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable electronic device with camera module comprising:
a main body;
a camera module received in the main body, the camera module comprising a first magnetic element; and
an attachable lens module, the attachable lens module comprising a second magnetic element;
wherein, the camera module and the attachable lens module are connected by the first and the second magnetic elements.

2. The portable electronic device in accordance with claim 1, wherein the main body defines a receiving cavity, the camera module received in the receiving cavity.

3. The portable electronic device in accordance with claim 1, wherein the camera module comprises an image pick-up lens unit and an image sensor.

4. The portable electronic device in accordance with claim 3, wherein the image pick-up lens unit is selected from a fix focus lens unit and a zoom lens unit.

5. The portable electronic device in accordance with claim 3, wherein the image sensor is selected from CCD and CMOS.

6. The portable electronic device in accordance with claim 1, wherein the attachable lens module comprises a lens barrel and an optical lens unit.

7. The portable electronic device in accordance with claim 6, wherein the optical lens unit is selected from the group comprising fix focus lens units, zoom lens units, telescopic lens units and tele-converter lenses.

8. The portable electronic device in accordance with claim 1, wherein the first and the second magnetic elements are both made from permanently magnetic material.

9. The portable electronic device in accordance with claim 1, wherein the first magnetic element is made from permanently magnetic material and the second magnetic element is made from a magnetizable metal.

10. The portable electronic device in accordance with claim 1, wherein the first and the second magnetic elements each employs a magnetic circle pad.

11. The portable electronic device in accordance with claim 1, wherein the first and the second magnetic elements are fixed at corresponding ends of the camera module and the attachable lens module, and the corresponding ends face towards each other.

12. The portable electronic device in accordance with claim 11, wherein the first and the second magnetic elements are stuck at the corresponding ends of the camera module and the attachable lens module.

13. The portable electronic device in accordance with claim 11, wherein the first and the second magnetic elements are attached using screw-thread to the corresponding ends of the camera module and the attachable lens module.

14. A portable electronic device comprising:
a main body;
a camera module buried in the main body, the camera module comprising an image pick-up lens unit;
a lens module detachably and magnetically attached to the camera module, the lens module comprising an optical lens unit.

15. The portable electronic device as claimed in claim 14, wherein a pair of magnetic elements is respectively fixed to the camera module and the lens module and configured for attaching the lens module to the camera module magnetically.

16. The portable electronic device as claimed in claim 15, wherein at least one of the magnetic elements is made from permanently magnetic material.

17. The portable electronic device as claimed in claim 14, wherein the lens module is located outside of the main body.

18. The portable electronic device as claimed in claim 14, wherein a hanging portion is arranged between the main body and the lens module and configured for hanging the lens module when the lens module is detached from the camera module.
